(19) United States
(12) Patent Application Publication
(10) Pub. No.: US 2010/0128032 A1
(43) Pub. Date: May 27, 2010

(54) RENDERING APPARATUS FOR CYLINDRICAL OBJECT AND RENDERING METHOD THEREFOR

(75) Inventors: Hye-Sun KIM,, Daejeon (KR); Chung Hwan Lee, Daejeon (KR); Yun Ji Ban, Daejeon (KR); Jin Sung Choi, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/469,513

(22) Filed: May 20, 2009

(30) Foreign Application Priority Data
Nov. 25, 2008 (KR) 10-2008-0117353

(51) Int. Cl. G06T 15/00

(52) U.S. Cl. 345/419

(57) ABSTRACT

A rendering apparatus for performing rendering of cylindrical objects includes: a data input unit image transmitting rendering data of individuals of the cylindrical objects which are classified by thickness when three dimensional model data of the cylindrical objects is input; a first rendering unit for performing an alpha line rendering for thin individuals of the cylindrical objects which are classified by thickness; and a second rendering unit for performing a ribbon triangulation rendering for thick individuals of the cylindrical objects which are classified by thickness. Further, the rendering apparatus includes a storage for integrating first rendering result data transmitted from the first rendering unit with second rendering result data transmitted from the second rendering unit to transmit final rendering result data; and a rendering output unit for outputting the final rendering result data.

### CROSS-REFERENCE TO RELATED APPLICATIONS

The present invention claims priority of Korean Patent Application No. 10-2008-0117353, filed on Nov. 25, 2008, which is incorporated herein by reference.

### FIELD OF THE INVENTION

The present invention relates to a rendering technique and, more particularly, to a rendering apparatus for a cylindrical object suitable for rendering inputted three dimensional data of a cylindrical object with respect to individuals and a rendering method therefore.

### BACKGROUND OF THE INVENTION

As well known in the art, technologies of naturally expressing many long cylindrical objects such as hair, fur, and lines on a virtual three dimensional image are roughly classified into four groups such as modeling of generating geometric information on fur and/or hair, a styling of naturally representing the object, a simulation of expressing a motion similar to a real motion and a rendering of a final three dimensional image.

Techniques of rendering the cylindrical objects are roughly classified into two methods, such as an explicit method and an implicit method. The explicit method is a method of expressing cylindrical objects individually in the form of triangle meshes and is classified into several methods according to how to form the triangle meshes. The implicit method expresses by binding several cylindrical objects in a three dimensional volume.

Since which renderer to use is determined according to selecting any one of the two rendering techniques, a user selects a desired rendering method. If the user hopes to use the explicit rendering method, a renderer having basic elements such as lines and triangles is required. Meanwhile, if the user hopes to use the implicit method, a renderer capable of expressing a three dimensional volume properly is required.

Particularly, in the explicit rendering method, the cylindrical object is inputted as a three dimensional curve with a preset thickness. In this case, the quantity of input data can be reduced. However, the input data cannot be used as it is and is further processed. In this processing step, the three dimensional curve is converted into various three dimensional geometrical information according to the rendering method.

Moreover, there are another methods such as a method of converting a two dimensional cylindrical object into a three dimensional cylindrical object, a method of converting the two dimensional cylindrical object into a planar ribbon perpendicular to a point of view, and a method of differentiating an expression degree of a cylindrical object according to a viewing distance such that a very distant object may become a planar ribbon.

However, according to the conventional rendering of the thin and many cylindrical objects by using the triangulation, since many sub-pixel samplings are performed in order to prevent jaggies of the triangular rendering and to improve quality thereof, it takes a long time for the rendering.

Moreover, in case of rendering using the triangulation, a fine cylindrical object is very thin and thus cannot be expressed correctly. Since the rendering is selectively performed according to a position of the cylindrical object and a point of view, an image contents including the cylindrical object twinkles when the image contents are animated. Consequently, since the rendering is occasionally performed in every frame repeatedly, smooth transition of overall animated image is disturbed.

### SUMMARY OF THE INVENTION

In view of the above, the present invention provides a cylindrical object rendering apparatus for rendering a cylindrical object by using a ribbon triangulated rendering or an alpha line rendering according to thickness of the cylindrical object and a rendering method thereof.

Further, the present invention provides a cylindrical object rendering apparatus for reducing rendering time through a ribbon triangulation rendering or an alpha line rendering according to thickness of a cylindrical object and for improving quality of the image and a rendering method thereof.

In accordance with a first aspect of the present invention, there is provided a rendering apparatus for performing rendering of cylindrical objects including: a data input unit image transmitting rendering data of individuals of the cylindrical objects which are classified by thickness when three dimensional model data of the cylindrical objects is input; a first rendering unit for performing an alpha line rendering for thin individuals of the cylindrical objects which are classified by thickness; a second rendering unit for performing a ribbon triangulation rendering for thick individuals of the cylindrical objects which are classified by thickness; a storage for integrating first rendering result data transmitted from the first rendering unit with second rendering result data transmitted from the second rendering unit to transmit final rendering result data; and a rendering output unit for outputting the final rendering result data.

In accordance with a second aspect of the present invention, there is provided a method for rendering cylindrical objects including: classifying the cylindrical objects into thin and thick individuals of the cylindrical objects by a preset thickness when three dimensional model data of the cylindrical objects is inputted; performing an alpha line rendering for the thin individuals of the cylindrical objects; performing a ribbon triangulation rendering for the thick individuals of the cylindrical objects; integrating first rendering result data which are stored by performing the alpha line rendering and the ribbon triangulation rendering into final rendering result data; and outputting the final rendering result data.

In accordance with the present invention, differently from the existing method of rendering a cylindrical object by using a ribbon triangulation, the alpha line rendering or the ribbon triangulation rendering is performed according to thickness of the cylindrical object so that the rendering is faster and more efficient than the conventional method using only the ribbon triangulation rendering and a more excellent rendered image can be output. Therefore, the twinkling can be reduced when the rendering is performed.

Specifically, when three dimensional model data of a cylindrical object is input, the cylindrical object is classified into a thinner cylindrical object and a thicker cylindrical object by using rendering data corresponding to the three dimensional model data, an alpha line rendering is performed for the thinner cylindrical object and a ribbon triangulation rendering is performed for the thicker cylindrical object, and a final rendering result data is output by combining the respective rendering result data. Accordingly, drawbacks of the conventional rendering apparatus and method can be solved.

### BRIEF DESCRIPTION OF THE DRAWINGS

The objects and features of the present invention will become apparent from the following description of embodiments given conjunction with the accompanying drawings, in which:

FIG. 1 is a block diagram illustrating a cylindrical object rendering apparatus suitable for rendering a cylindrical object according to thickness of the cylindrical object in accordance with an embodiment of the present invention;

FIG. 2A illustrates three dimensional model data of a cylindrical object which is inputted into a data input unit in accordance with the embodiment of the present invention;

FIG. 2B illustrates an output image of rendering result data to which an alpha line rendering is performed in accordance with the embodiment of the present invention;

FIG. 2C illustrates an output image of rendering result data to which a ribbon triangulation rendering is performed according to the embodiment of the present invention;

FIG. 2D illustrates an output image of a final rendering in accordance with the embodiment of the present invention;

FIG. 3A illustrates an individual of cylindrical objects relatively thinner than one square pixel in accordance with the embodiment of the present invention;

FIG. 3B illustrates an alpha line rendering for a thin individual of the cylindrical objects in accordance with the embodiment of the present invention;

FIG. 4A illustrates an individual of cylindrical objects relatively thicker than one square pixel in accordance with the embodiment of the present invention;

FIG. 4B illustrates a ribbon triangulation rendering for a thick individual of the cylindrical objects in accordance with the embodiment of the present invention;

FIG. 5A illustrates a rendering buffer of a conventional pipeline;

FIG. 5B is a view illustrating a depth render buffer having a depth value in accordance with the embodiment of the present invention; and

FIG. 6 is a flowchart illustrating a method of performing an alpha line rendering or a ribbon triangulation rendering according to thickness of a cylindrical object to output a rendered image in accordance with the embodiment of the present invention.

### DETAILED DESCRIPTION OF THE EMBODIMENTS

Hereinafter, embodiments of the present invention will be described in detail with reference to the accompanying drawings which form a part hereof.

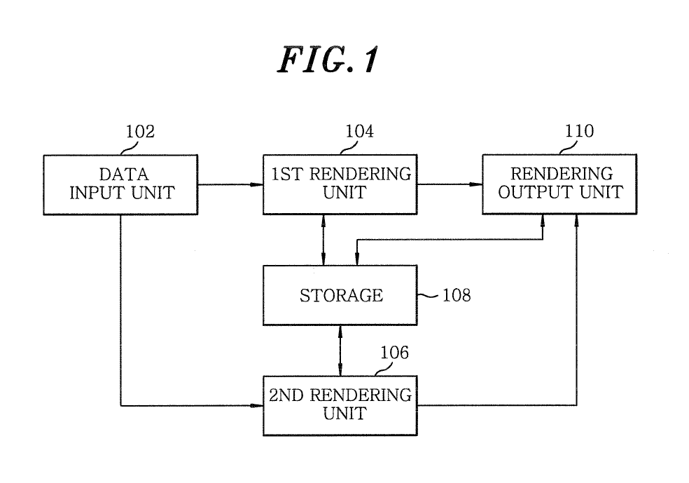

FIG. 1 is a block diagram illustrating a cylindrical object rendering apparatus suitable for rendering a cylindrical object according to thickness of the cylindrical object in accordance with an embodiment of the present invention, the cylindrical object rendering apparatus includes a data input unit 102, a first rendering unit 104, a second rendering unit 106, a storage 108, and a rendering output unit 110.

Referring to FIG. 1, when three dimensional (3D) model data of cylindrical objects, e.g., fur, hair or the like to be rendered is input, the data input unit 102 compares thicknesses of the cylindrical objects with a preset thickness, e.g., one pixel individually and classifies the cylindrical objects according to thicknesses of the cylindrical objects. When the thickness of a corresponding cylindrical object is less than the preset thickness, the data input unit 102 transmits rendering data of the corresponding cylindrical object to the first rendering unit 104. When the thickness of a cylindrical object is greater than the preset thickness, the data input unit 102 transmits rendering data of a corresponding cylindrical object to the second rendering unit 106. In this case, the rendering data includes 3D curve data consisting of a set of individual center points of the cylindrical objects, and individual thickness information of the cylindrical objects, wherein the individual thickness information of the cylindrical objects includes, for example, root thickness and tip thickness of individuals of the cylindrical objects.

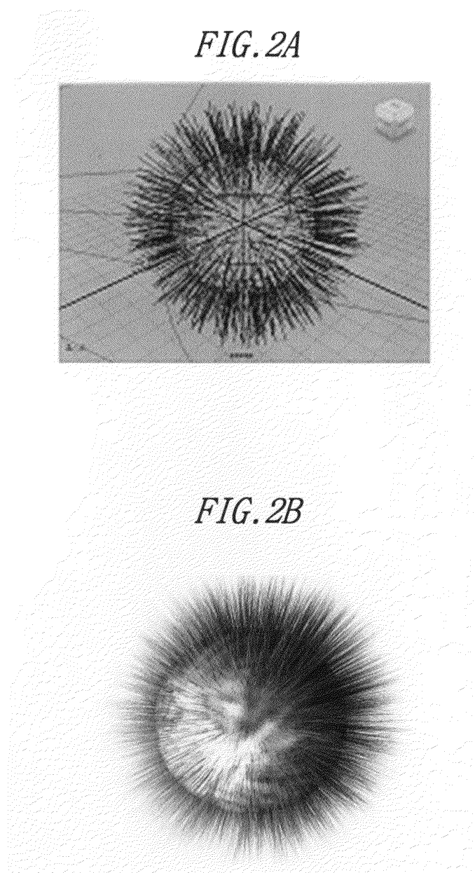

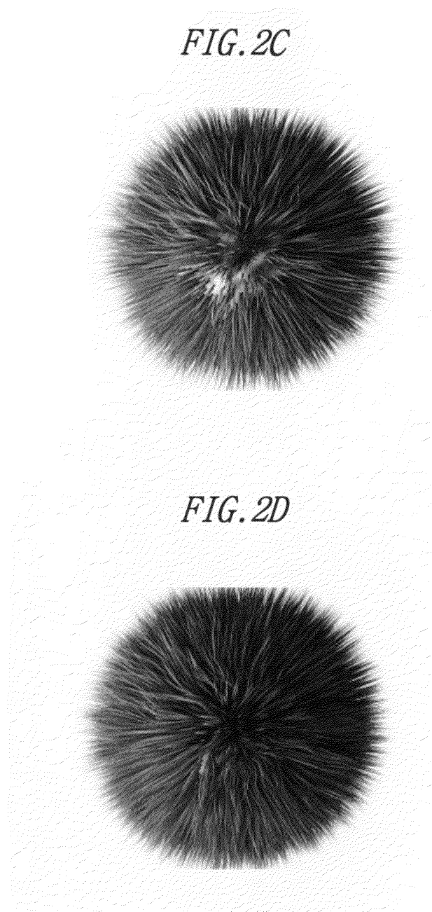

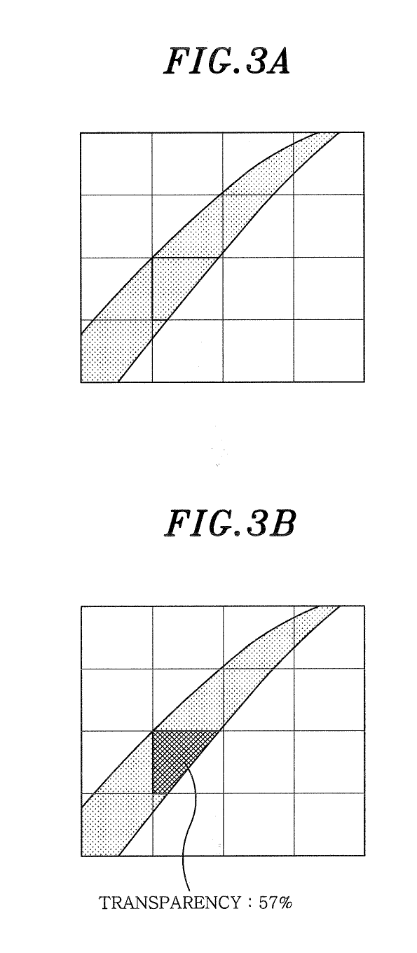

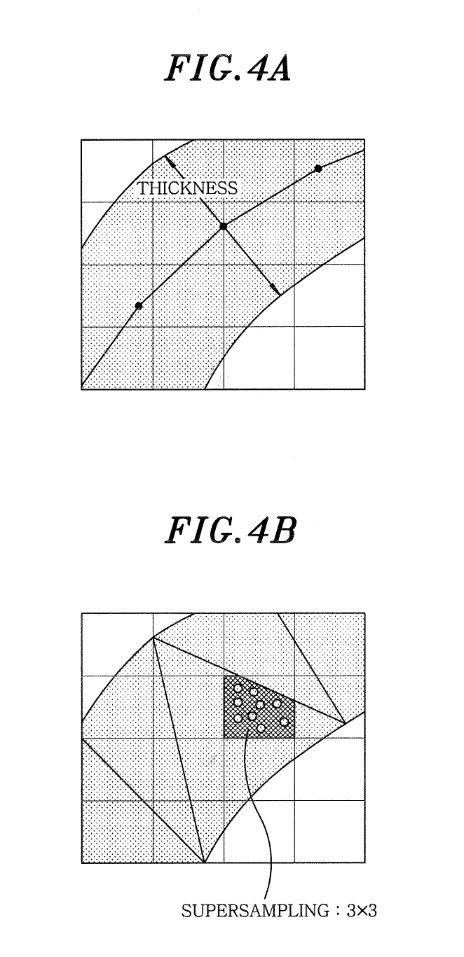

For example, FIG. 2A illustrates three dimensional model data of a cylindrical object which is inputted into a data input unit 102 in accordance with the embodiment of the present invention, FIG. 3A illustrates an individual of the cylindrical object relatively thinner than one square pixel in accordance with the embodiment of the present invention, and FIG. 4A illustrates an individual of the cylindrical object relatively thicker than one square pixel in accordance with the embodiment of the present invention. The data input unit 102 classifies the individuals of the cylindrical objects into thin and thick individuals of the cylindrical objects according to the preset thickness, e.g., one pixel by using the 3D model data of the cylindrical objects, and can transmit the rendering data of the individuals to the first rendering unit 104 and the second rendering unit 106.

The first rendering unit 104 renders the cylindrical objects by using an alpha line rendering module. When the rendering data of the thin individuals of the cylindrical objects is inputted from the data input unit 102, the first rendering unit 104 estimates an area of a region to be rendered by every pixel and performs the rendering by taking the estimated area as transparency. In this case, the area in a corresponding pixel is estimated by which whole rendering regions of corresponding individuals are separated pixel by pixel and rectangular region estimation is performed according to each distance of X-axis and Y-axis of a region where a dark color appears in every pixel.

For example, FIG. 3B illustrates an alpha line rendering for a thin object in accordance with the embodiment of the present invention. In this case, when one pixel has an area of 1 (one), “(area of a corresponding region)/1” is transparency of a corresponding pixel, however, since, as illustrated in FIG. 3B, area of a dark region is about 0.57, the transparency of the dark region is 57% and is applied to estimate a color value of a corresponding pixel. The color value can be estimated by using “color=sourceColor*opacity+backgroundcolor*(1−opacity)”.

The first rendering unit 104 stores result data of the first rendering in the storage 108 after performing the rendering for the thin individuals of the cylindrical objects. For example, FIG. 2B illustrates an output image of a result rendering data to which an alpha line rendering is performed for the thin individuals of the cylindrical objects in accordance with the embodiment of the present invention.

Meanwhile, the second rendering unit 106 renders the cylindrical objects by using a ribbon triangular rendering module. When rendering data of thick individuals of the cylindrical objects is transmitted from the data input unit 102, the second rendering unit 106 recomposes the rendering data of the individuals in the form of a triangulated ribbon. The triangulated ribbons are planes respectively perpendicular to a point of view of a viewer and their sizes are determined by the input thicknesses of the individuals. The recomposed triangulated ribbons are rendered in a rendering pipeline.

For example, FIG. 4B illustrates a ribbon triangulation rendering to thick individuals of cylindrical objects in accordance with the embodiment of the present invention. Rendering data of respective individuals of the cylindrical objects are recomposed in the form of triangulated ribbons, respective pixels in the triangulated ribbons are supersampled by a plurality of sub-pixels (for example, 3*3), and each information of the sub-pixels is integrated to estimate a color value and transparency of a corresponding pixel.

Moreover, the second rendering unit 106 renders the thick individuals of the cylindrical objects and stores result data thereof to the storage 108. For example, FIG. 2C illustrates an output image of rendering result data to which a ribbon triangulation rendering is performed to the thick individuals of the cylindrical objects in accordance with the embodiment of the present invention.

The storage 108 temporally stores the rendering result data including depth render buffer. The storage 108 stores the first result data of the thin individuals of the cylindrical objects which is transmitted from the first rendering unit 104, and integrates or mixes the second rendering result data of the thick individuals of the cylindrical objects which is transmitted from the second rendering unit 104 with the first result rendered data to transmit final rendering result data to the rendering output unit 110. The depth render buffer is a rendering buffer having XYZ 3D depths and is mainly used to render transparent objects which cannot be arranged. The depth render buffer is a structuralized buffer wherein many individuals and complicated objects such as cylindrical object of fur, hair and the like are not arranged in advance but with links to be stored.

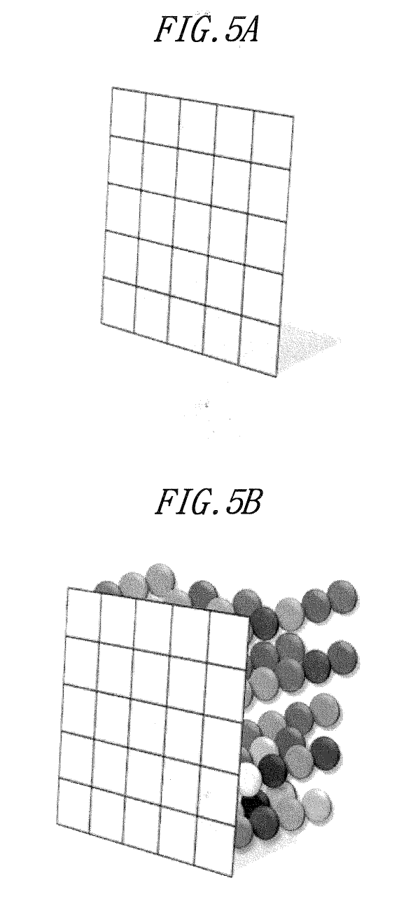

For example, FIG. 5A illustrates a rendering buffer of a conventional pipeline, and FIG. 5B is a view illustrating a depth render buffer having a depth value in accordance with the embodiment of the present invention. Differently from FIG. 5A illustrating a conventional rendering buffer, a plurality of nodes are connected to an X-Y plane by links as illustrated in FIG. 5B. The respective nodes are result of rendering a transparent object and each has a “color value”, a “transparency value” and a “depth value”. The nodes are sequentially sorted from near nodes to far nodes according to the depth. A final rendering image can be created by integrating the nodes by sequentially accumulating and summing the respective node from the near nodes to the far nodes. For example, the color value can be estimated by using “color=node1Color*node1Opacity+Sum (node1˜nColor)*(1−node1Opacity).”

Then, the rendering output unit 110 outputs data of final rendering result transmitted from the storage 108 on a display device, e.g., a monitor as an output image. For example, FIG. 2D illustrates an output image of a final rendering result in accordance with the embodiment of the present invention. The first rendering result data obtained by performing the alpha line rendering for the thin individuals of the cylindrical objects are integrated or mixed with the second rendering result data obtained by performing the ribbon triangulation rendering for the thick individuals of the cylindrical objects so that the final rendering result data can be output as an image.

Hereinafter, a process of comparing thickness of cylindrical objects with a preset thickness to classify the cylindrical objects into thin cylindrical objects and thick cylindrical objects, respectively when 3D model data of the cylindrical objects are inputted to the cylindrical object rendering apparatus, of performing an alpha line rendering for the thin cylindrical objects, of performing a ribbon triangulation rendering for the thick cylindrical objects, of integrating the rendering result data by using a depth render buffer, and of outputting an image corresponding to a final rendering result data will be described.

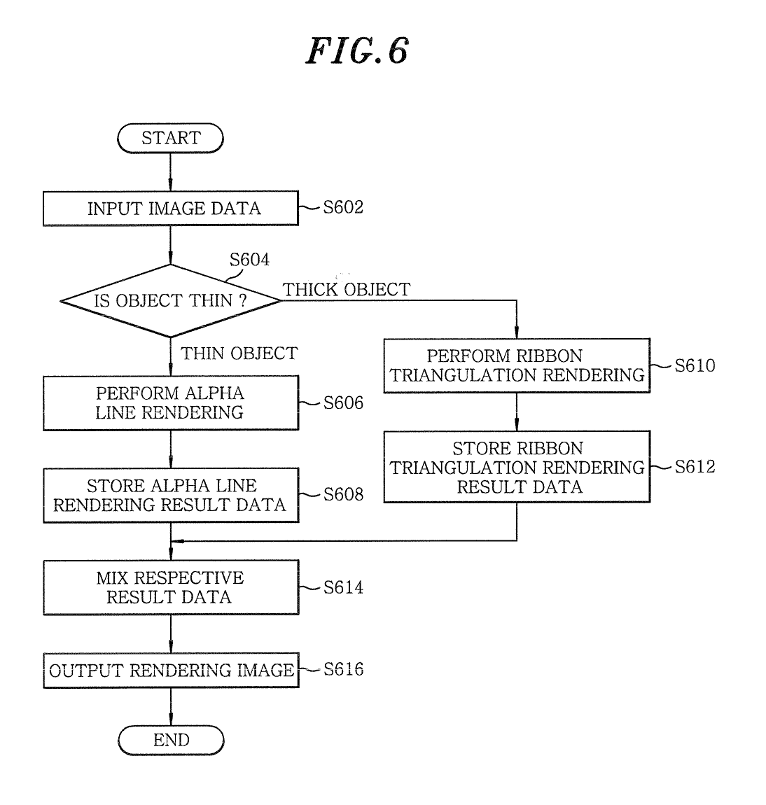

FIG. 6 is a flowchart illustrating a method of performing an alpha line rendering or a ribbon triangulation rendering according to thickness of a cylindrical object to output a rendered image in accordance with the embodiment of the present invention.

Referring to FIG. 6, when 3D model data of cylindrical objects such as fur, hair and the like to be rendered are input (S602), the data input unit 102 checks the cylindrical objects according to thickness (S604).

When an individual of the cylindrical objects is thinner than a preset thickness, e.g., one pixel as a result of the checking in step 604, the data input unit 102 transmits rendering data of the thin individual of the cylindrical objects to the first rendering unit 104 such that the first rendering unit 104 performs the alpha line rendering by using the rendering data of the thin individual of the cylindrical objects (S606).

Here, the rendering data includes 3D curve data consisting of a set of center points of the individuals of the cylindrical objects and thickness information of the individuals of the cylindrical objects and the like, and the thickness information of the individuals of the cylindrical objects includes root thickness and tip thickness of the individuals.

Moreover, the alpha line rendering is a method of estimating an area of a region in every pixel to be rendered from the input rendering data and of performing the rendering by taking the estimated area as transparency of the pixels. In the alpha line rendering, the area in a corresponding pixel can be estimated by which whole rendering regions of corresponding individuals are separated pixel by pixel and rectangular region estimation is performed according to each distance of X-axis and Y-axis of a region where a dark color appears in every pixel.

The first rendering unit 104 performs the rendering for the thin cylindrical objects and stores the first rendering result data to the storage 108 (S608).

Meanwhile, when an individual of the cylindrical objects is thicker than a preset thickness, e.g., one pixel as a result of the checking in step 604, the data input unit 102 transmits rendering data of the thick individual of the cylindrical objects to the second rendering unit 106 such that the second rendering unit 106 performs the ribbon triangulation rendering by using the rendering data of the thick individual of the cylindrical objects (S610).

In this case, the rendering data includes 3D curve data consisting of a set of center points of the individuals of the cylindrical objects and thickness information of the individuals of the cylindrical objects and the like, and the thickness information of the individuals of the cylindrical objects includes root thickness and tip thickness of the individuals.

Moreover, the ribbon triangulation rendering is a method of recomposing the rendering data of the respective individuals of the cylindrical objects into the triangulated ribbons. The triangulated ribbons have planes respectively perpendicular to a point of view of a viewer and sizes thereof are determined by the input thicknesses of the individuals so that the recomposed triangulated ribbons are rendered in the rendering pipelines. Rendering data of respective individuals of the cylindrical objects are recomposed in the form of triangulated ribbons, respective pixels in the triangulated ribbons are supersampled by a plurality of sub-pixels (for example, 3*3), and information of the respective sub-pixels can be integrated to estimate a color value and transparency value of a corresponding pixel.

Then, the second rendering unit 106 performs the rendering for the thick individuals of the cylindrical objects and stores the second rendering result in the storage 108 (S612).

Next, the storage 108 stores the first rendering result data of the thin individuals of the cylindrical objects which is transmitted from the first rendering unit 104, and integrates or mixes the second rendering result data of the thick individuals of the cylindrical objects which is transmitted from the second rendering unit 106 with the first rendering result data to transmit final rendering result data to the rendering output unit 110 (S614).

Then, the rendering output unit 110 outputs the final rendering result data transmitted from the storage 108 on the display device as an image (S616).

Consequently, in the rendering of the cylindrical objects, the thin cylindrical object is rendered by the alpha line rendering and the thick cylindrical object is rendered by the ribbon triangulation rendering, and the rendering result data are integrated to output the final rendering result data as an image.

While the invention has been shown and described with respect to the embodiments, it will be understood by those skilled in the art that various changes and modifications may be made without departing from the scope of the invention as defined in the following claims.

What is claimed is:

1. A rendering apparatus for performing rendering of cylindrical objects, comprising:
a data input unit image transmitting rendering data of individuals of the cylindrical objects which are classified by thickness when three dimensional model data of the cylindrical objects is input;
a first rendering unit for performing an alpha line rendering for thin individuals of the cylindrical objects which are classified by thickness;
a second rendering unit for performing a ribbon triangulation rendering for thick individuals of the cylindrical objects which are classified by thickness;
a storage for integrating first rendering result data transmitted from the first rendering unit with second rendering result data transmitted from the second rendering unit to transmit final rendering result data; and
a rendering output unit for outputting the final rendering result data.

2. The rendering apparatus of claim 1, wherein the data input unit compares thickness of the individuals of the cylindrical objects with a preset thickness to classify the cylindrical objects into thin and thick cylindrical objects, respectively.

3. The rendering apparatus of claim 1, wherein the first rendering unit estimates an area of a region to be rendered in a pixel from rendering data of the thin individuals of the cylindrical objects transmitted from the data input unit, respectively and performs the alpha line rendering by taking the estimated area as transparency of the pixel.

4. The rendering apparatus of claim 3, wherein the alpha line rendering is performed by separating whole rendering regions of the rendering data pixel by pixel and by estimating each area of corresponding pixels in each rectangular region with each length of X-axis and Y-axis of the rectangular region where a dark color appears.

5. The rendering apparatus of claim 1, wherein the second rendering unit recomposes rendering data of the thick individuals of the cylindrical objects into triangulated ribbons and performs the ribbon triangulation rendering.

6. The rendering apparatus of claim 5, wherein the ribbon triangulation rendering is performed by recomposing the rendering data, supersampling respective pixels of the triangulated ribbons by a plurality of sub-pixels, and integrating information of the respective sub-pixels to estimate a color value and transparency value of a corresponding pixel.

7. The rendering apparatus of claim 4, wherein the rendering data comprises three dimensional curve data consisting of center points of the individuals of the cylindrical objects and thickness information of the individuals of the cylindrical objects.

8. The rendering apparatus of claim 7, wherein the thickness information of the individuals of the cylindrical objects comprises root thickness and tip thickness of the individuals of the cylindrical objects.

9. The rendering apparatus of claim 2, wherein the storage integrates the first and the second rendering result data into the final rendering result data by using a depth render buffer.

10. A method for rendering cylindrical objects, comprising:
classifying the cylindrical objects into thin and thick individuals of the cylindrical objects by a preset thickness when three dimensional model data of the cylindrical objects is inputted;
performing an alpha line rendering for the thin individuals of the cylindrical objects;
performing a ribbon triangulation rendering for the thick individuals of the cylindrical objects;
integrating first rendering result data which are stored by performing the alpha line rendering and the ribbon triangulation rendering into final rendering result data; and
outputting the final rendering result data.

11. The method of claim 10, wherein the method classifies the cylindrical objects into the thin and thick individuals and transmits rendering data corresponding to the respective individuals.

12. The method of claim 11, wherein the rendering data comprises three dimensional curve data consisting of center points of the individuals of the cylindrical objects and thickness information of the individuals of the cylindrical objects.

13. The method of claim 12, wherein the thickness information of the individuals of the cylindrical objects comprises root thickness and tip thickness of the individuals of the cylindrical objects.

14. The method of claim 11, wherein an area of a region to be rendered in a pixel is estimated from rendering data of the thin individuals of the cylindrical objects transmitted from the data input unit, respectively and the alpha line rendering is performed by taking the estimated area as transparency value of the pixel.

15. The method of claim 14, wherein the alpha line rendering is performed by separating whole rendering regions of the rendering data pixel by pixel and by estimating each area of corresponding pixels in each rectangular region with each length of X-axis and Y-axis of the rectangular region where a dark color appears.

16. The method of claim 11, wherein rendering data of the thick individuals of the cylindrical objects is recomposed into triangulated ribbons and ribbon triangulation rendering is performed.

17. The method of claim 16, wherein the ribbon triangulation rendering is performed by recomposing the rendering data, supersampling respective pixels of the triangulated ribbons by a plurality of sub-pixels, and integrating information of the respective sub-pixels to estimate a color value and transparency value of a corresponding pixel.

18. The method of claim 11, wherein the respective rendering result data are integrated into the final rendering result data by using a depth render buffer.
